(19) United States
(12) Patent Application Publication
(10) Pub. No.: US 2010/0002461 A1
(43) Pub. Date: Jan. 7, 2010

(54) LIGHT GUIDE BAR WITH PATTERNED SURFACE TO ENHANCE LIGHT UNIFORMITY AND INTENSITY

(76) Inventors: Rong-Yaw WU, Hsin-Tien City (TW); Chih Ming Yen, Hsin-Tien City (TW); Chien Liang Liao, Hsin-Tien City (TW); Yen-Chieh Chen, Hsin-Tien City (TW)

Correspondence Address: SINORICA, LLC, 2275 Research Blvd., Suite 500, ROCKVILLE, MD, 20850, US

(21) Appl. No.: 12/166,409

(22) Filed: Jul. 2, 2008

(51) Int. Cl. G02B 5/02

(52) U.S. Cl. 362/558

(57) ABSTRACT

A light guide bar with a patterned surface for a flicker free light source comprising a light emitting diode (LED) light source disposed on each end of the light guide bar is disclosed. A light diffusing pattern is disposed on a light emitting surface. The light diffusing pattern comprises a plurality of notches that are smallest closest to the LED light sources and largest in the center of the light guide bar. A light reflecting pattern is disposed on a light reflecting surface opposite the light diffusing pattern on the light emitting surface. Light emitted by the LED light sources enters the light guide bar through the ends. The light travels through the light guide bar at various angles and is reflected by the light reflecting pattern on the light reflecting surface. The reflected light is then emitted through the light diffusing pattern on the light emitting surface.

### BACKGROUND OF THE INVENTION

1. Field of the Invention

The present invention relates to a light source. More specifically, the present invention discloses a highly efficient light source that does not flicker and provides a uniform emitted light.

2. Description of the Prior Art

Linear light sources emit light in a different direction from the direction the light originated from. For example, a light is produced by a light emitting diode at an angle of zero degrees. By affecting the direction of the light beam the linear light source can emit the light at various angles such as 90 degrees.

Refer to FIG. 1, which is a drawing illustrating a light source of the prior art. As shown in FIG. 1, the conventional light source comprises a light emitting diode 110 and a transparent light rod 120. Both ends of the transparent light rod 120 are flat surfaces. When power is applied to the light emitting diode 110 the light emitting diode 110 emits light. Some of the light enters the transparent light rod 120. However, since the end of the transparent light rod 120 is flat, much of the light is reflected back and is lost. This lowers the efficiency and intensity of the light source.

The light that enters the transparent light rod 120 exits the side surface of the transparent light rod 120. Unfortunately, some of the light exits the transparent light rod 120 in directions not intended. This results in an additional loss of light. To overcome this disadvantage a reflective housing must be used in order to try to reflect the escaping light back into the transparent light rod 120. This increases the cost of the light source.

Additionally, since only one light emitting diode 110 is utilized in the conventional light source the emitted light is brighter closer to the light emitting diode 110 and dimmer at the far end of the transparent light rod 120. As a result the conventional light source's emitted light is not uniform.

Therefore, there is need for an improved light source that is highly efficient, does not flicker, and provides an emitted light that is uniform in intensity.

### SUMMARY OF THE INVENTION

To achieve these and other advantages and in order to overcome the disadvantages of the conventional method in accordance with the purpose of the invention as embodied and broadly described herein, the present invention provides a highly efficient light source that does not flicker and provides a uniform emitted light.

The flicker free light source comprises at least one light emitting diode (LED) light source disposed on each end of a light guide bar. The light guide bar is comprised of transparent or semi-transparent material. The light guide bar is solid, semi-hollow or hollow.

In addition the light guide bar of the flicker free light source further comprises a light diffusing pattern on a light emitting surface. Light emitted by the LED light sources enters the light guide bar through the two ends. The light exits the light guide bar on the light emitting surface. The light diffusing pattern diffuses the light as it exits and makes the emitted light more uniform in intensity thereby enhancing the quality of the flicker free light source.

The light diffusing pattern on the light emitting surface comprises a plurality of notches and edges. The peaks of the notches are highest and the valleys of the notches are deepest on the light guide bar furthest away from the LED light sources. The farther away from the LED light sources the size of the notches of the light diffusing pattern get larger. In this way the light diffusing pattern diffuses the light more gently where the light intensity is strongest (closer to the LED light sources). Moving towards the LED light sources, the size of the notches of the light diffusing pattern gets increasingly smaller.

The flicker free light source further comprises a light reflecting pattern on the light guide bar. The light reflecting pattern is on a light reflecting surface opposite the light diffusing pattern on the light emitting surface. Light emitted by the LED light sources enters the light guide bar through the ends. The light travels through the light guide bar at various angles and is reflected by the light reflecting pattern on the light reflecting surface. The reflected light is then emitted through the light diffusing pattern on the light emitting surface.

Since the light source of the present invention utilizes LED light sources, the emitted light does not flicker and the light source turns on instantly without delay. Once turned on the light source immediately begins emitting a stable visible light.

An object of the present invention is to provide a low power light source that uses little electricity and has a long lifetime. This results in major cost savings in the long run for consumers.

The flicker free light source of the present invention replaces conventional linear light sources, fluorescent light bulbs and fixtures, and incandescent light bulbs and fixtures.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The patent or application file contains at least one drawing executed in color. Copies of this patent or patent application publication with color drawing(s) will be provided by the office upon request and payment of the necessary fee.

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a drawing illustrating a light source of the prior art;

FIG. 2A is a drawing illustrating a flicker free light source with a light guide bar according to an embodiment of the present invention;

FIG. 2B is a drawing illustrating a flicker free light source with a light guide bar having a light diffusing patterned surface according to an embodiment of the present invention;

FIGS. 2C-2E are drawings illustrating a light diffusing pattern on a light guide bar according to embodiments of the present invention;

FIGS. 2F-2H are drawings illustrating a flicker free light source with a light guide bar with a light diffusing patterned surface and a light reflecting patterned surface according to embodiments of the present invention;

FIGS. 2Ia-2N are drawings illustrating a light diffusing pattern and a light reflecting pattern according to embodiments of the present invention;

FIGS. 2O-2Q are drawings illustrating a cylindrical light guide bar with patterned surfaces according to embodiments of the present invention;

FIGS. 2R-2T are drawings illustrating an end view of a light guide bar for a flicker free light source according to embodiments of the present invention;

FIGS. 2U-2X are drawings illustrating an end view of a polygonal light guide bar for a flicker free light source according to embodiments of the present invention;

FIG. 2Y is a drawing illustrating a side view of a light reflecting pattern for a light guide bar according to an embodiment of the present invention;

FIG. 2Z is a drawing illustrating a view of a light reflecting pattern for a light guide bar according to an embodiment of the present invention;

FIGS. 3A-3D are drawings illustrating a polygonal light guide bar with a sigma shaped surface according to embodiments of the present invention;

FIGS. 3E-3F are drawings illustrating a cylindrical light guide bar with a sigma shaped surface according to embodiments of the present invention;

FIGS. 4A-4B are drawings illustrating a flicker free light source with a cylindrical light guide bar having a corkscrew light diffusion pattern according to embodiments of the present invention;

FIG. 5A is a drawing illustrating a flicker free light source with a cylindrical light guide bar having a light diffusing patterned surface and a light reflecting patterned surface according to an embodiment of the present invention;

FIG. 5B is a drawing illustrating a light guide bar with a patterned surface according to an embodiment of the present invention;

FIGS. 6A-6B are drawings illustrating LED arrangement for a flicker free light source according to embodiments of the present invention;

FIGS. 7A-7B are drawings illustrating LED coupling for a flicker free light source according to embodiments of the present invention;

FIGS. 8A-8B are drawings illustrating a flicker free light source with a light guide bar having concaved and slanted ends according to embodiments of the present invention;

FIG. 8C is a drawing illustrating an end view of a light guide bar according to an embodiment of the present invention;

FIG. 9 is a drawing illustrating an enlarged view of the light diffusing pattern and the light reflecting pattern according to an embodiment of the present invention; and

FIG. 10 is a diagram illustrating illumination results using the linear light source of the present invention.

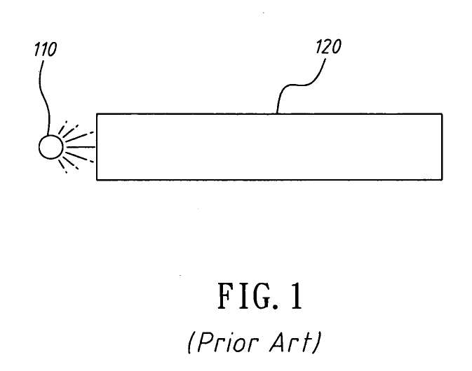

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

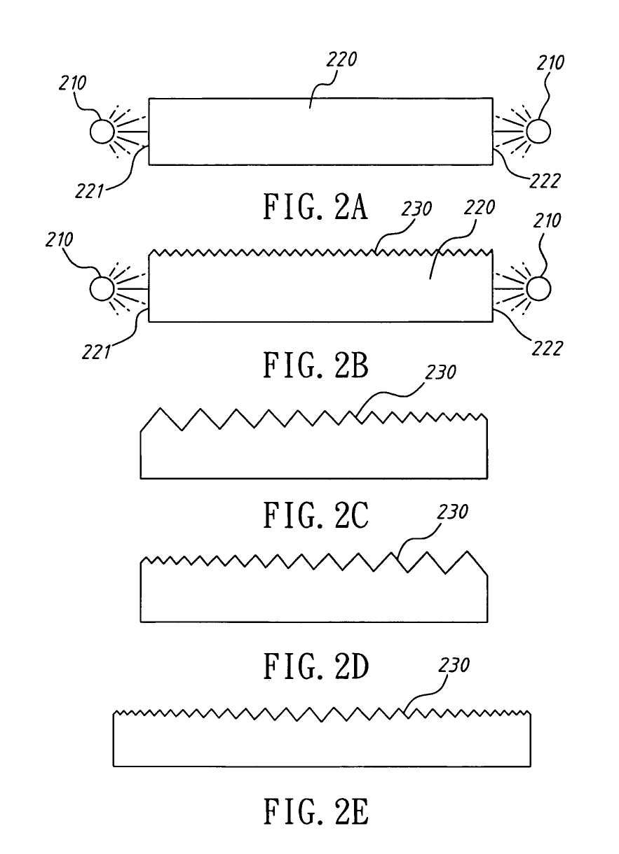

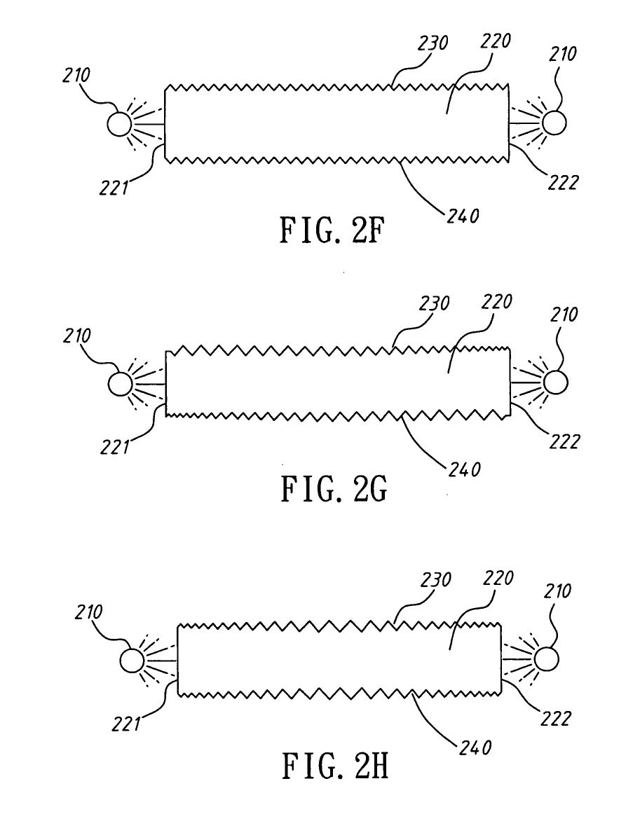

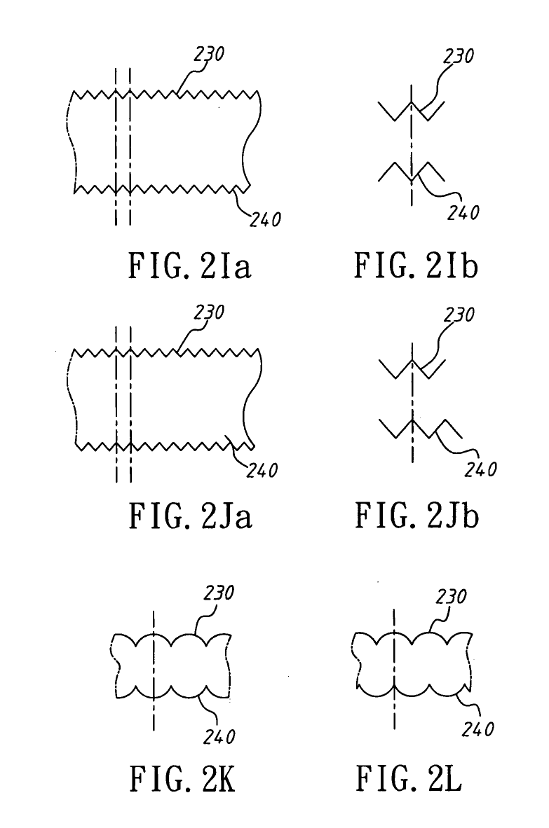

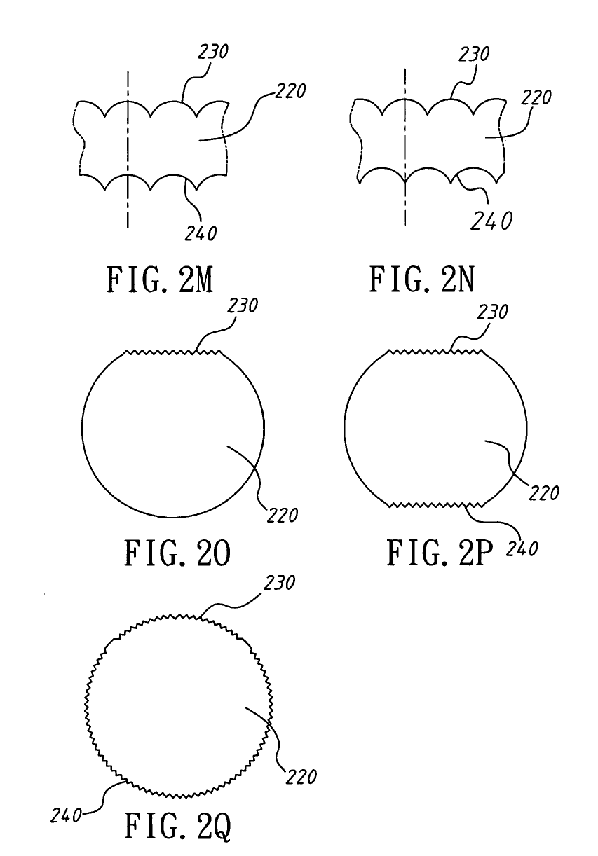

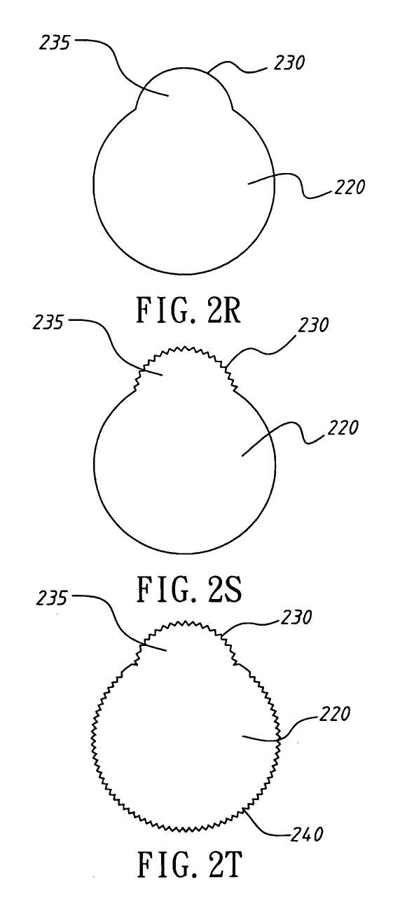

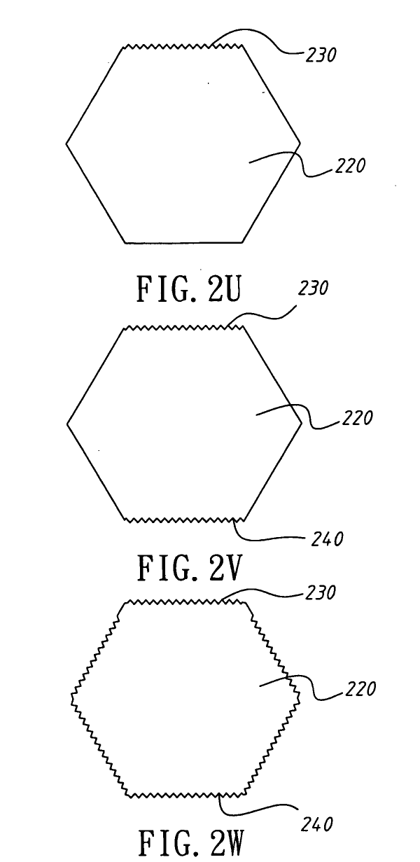

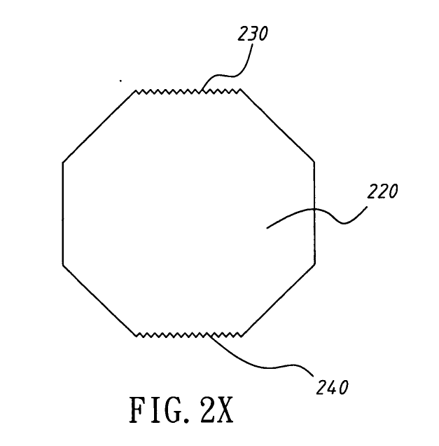

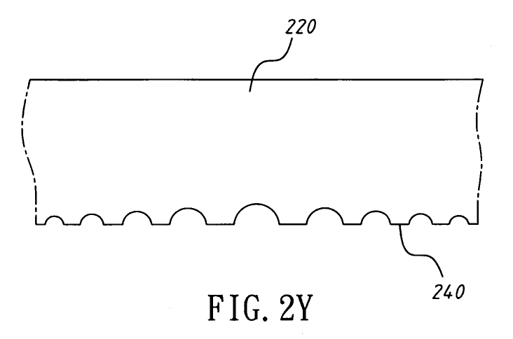

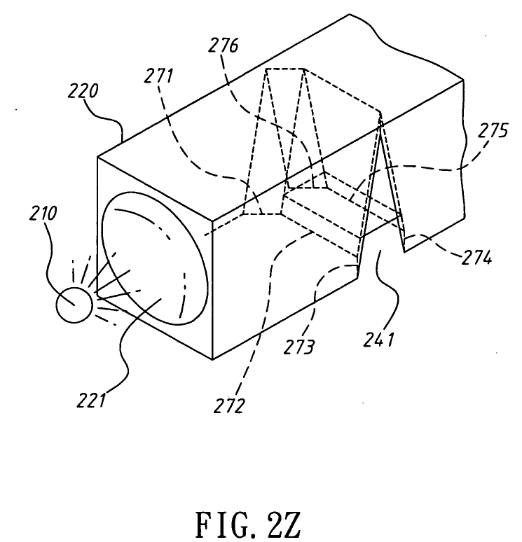

Refer to FIG. 2A, which is a drawing illustrating a flicker free light source with a light guide bar according to an embodiment of the present invention. The flicker free light source comprises a light emitting diode (LED) light source 210 disposed on each end of a light guide bar 220. The light guide bar 220 is comprised of transparent or semi-transparent material. The light guide bar is solid, hollow, or semi-hollow. The light guide bar 220 further comprises two ends 221 222.

Refer to FIG. 2B, which is a drawing illustrating a flicker free light source with a light guide bar having a light diffusing patterned surface according to an embodiment of the present invention.

As shown in FIG. 2B, in addition to the two ends 221 222 the light guide bar 220 of the flicker free light source further comprises a light diffusing pattern 230 on a light emitting surface. Light emitted by the LED light sources 210 enters the light guide bar 220 through the two ends 221 222. The light exits the light guide bar 220 on the light emitting surface. The light diffusing pattern 230 diffuses the light as it exits and makes the emitted light more uniform in intensity thereby enhancing the quality of the flicker free light source.

Refer to FIGS. 2C-2E, which are drawings illustrating a light diffusing pattern on a light guide bar according to embodiments of the present invention.

In the embodiment shown in FIG. 2C, the light diffusing pattern 230 on the light emitting surface comprises a plurality of notches. The peaks of the notches are highest and the valleys of the notches are deepest at the end of the light guide bar further away from the LED light source. The farther away from the LED light source the size of the notches of the light diffusing pattern 230 get larger. In this way the light diffusing pattern 230 diffuses the light more gently where the light intensity is strongest (closer to the LED light source). Moving away from the LED light source the size of the notches of the light diffusing pattern 230 gets increasingly larger. In this embodiment a single LED light source is utilized and positioned on the left side of the drawing.

The embodiment illustrated in FIG. 2D is similar to the embodiment shown in FIG. 2C but with the single LED light source positioned on the right side of the drawing.

In the embodiment illustrated in FIG. 2E two LED light sources are utilized, one positioned on the left side of the drawing and one positioned on the right side of the drawing. The light diffusing pattern 230 on the light emitting surface of the light guide bar is designed so that the light is diffused more gently where the light intensity is strongest. Moving away from the LED light sources the notches of the light diffusing pattern 230 become increasingly larger. Light emitted by the LED light sources enter the light guide bar through the ends of the light guide bar. The light travels through the light guide bar and after being reflected or diffused by the light diffusing surface exits the light emitting surface of the light guide bar.

Refer to FIGS. 2F-2H, which are drawings illustrating a flicker free light source with a light guide bar with a light diffusing patterned surface and a light reflecting patterned surface according to embodiments of the present invention.

In the embodiment illustrated in FIG. 2F the flicker free light source further comprises a light reflecting pattern 240 on the light guide bar 220. The light reflecting pattern 240 is on a light reflecting surface opposite the light diffusing pattern 230 on the light emitting surface. Light emitted by the LED light sources 210 enters the light guide bar 220 through the ends 221 222. The light travels through the light guide bar 220 at various angles and is reflected by the light reflecting pattern 240 on the light reflecting surface. The reflected light is then emitted through the light diffusing pattern 230 on the light emitting surface. In this embodiment the light diffusing pattern 230 and the light reflecting pattern 240 are identical and comprise a plurality of notches or indentations of uniform size.

In the embodiment illustrated in FIG. 2G the light diffusing pattern 230 is similar to the light diffusing pattern illustrated in FIG. 2C and the light reflecting pattern 240 is similar to the light diffusing pattern illustrated in FIG. 2D. In this embodiment the light diffusing pattern 230 and the light reflecting pattern cooperate to reflect and diffuse the light in order to provide an emitted light of uniform intensity and high efficiency.

In the embodiment illustrated in FIG. 2H, the light diffusing pattern 230 and the light reflecting pattern 240 are similar to the light diffusing pattern illustrated in FIG. 2E. The notches of the patterns are smaller in size closest to the LED light sources 210. Moving away from the LED light sources 210 the sizes of the notches are gradually increased where the light intensity would normally be weakest. As a result, extra light is reflected and emitted at the center of the light guide bar 220 to compensate. In this way the flicker free light source provides a uniform light throughout the length of the light emitting surface.

Refer to FIGS. 2Ia-2N, which are drawings illustrating a light diffusing pattern and a light reflecting pattern according to embodiments of the present invention.

In the embodiment illustrated in FIG. 2Ia and FIG. 2Ib the light diffusing pattern 230 and the light reflecting pattern 240 are positioned so that the notches of both patterns are aligned. In the embodiment illustrated in FIG. 2Ja and FIG. 2Jb the notches of the light diffusing pattern 230 and the light reflecting pattern 240 are offset by 50%. In embodiments of the present invention the light diffusing pattern 230 and the light reflecting pattern 240 comprise patterns as illustrated in FIGS. 2F-2H and positioned in aligned and offset orientations.

In the embodiment illustrated in FIG. 2K the light diffusing pattern 230 and the light reflecting pattern 240 comprise a plurality of convex mounds. In this embodiment the convex mounds of the light diffusing pattern 230 and the light reflecting pattern 240 are aligned. In the embodiment illustrated in FIG. 2L the convex mounds of the light diffusing pattern 230 and the light reflecting pattern 240 are offset by 50%. In some embodiments of the present invention the convex mounds are uniform. In other embodiments of the present invention the convex mounds of the light diffusing pattern and the light reflecting pattern increase in size moving farther away from the LED light sources.

In the embodiment illustrated in FIG. 2M the light diffusing pattern 230 comprises a plurality of convex mounds and the light reflecting pattern 240 comprises a plurality of concaved dishes. In this embodiment the light diffusing pattern 230 and the light reflecting pattern 240 are aligned. In the embodiment illustrated in FIG. 2N the light diffusing pattern 230 and the light reflecting pattern 240 are offset by 50%.

Refer to FIGS. 2O-2Q, which are drawings illustrating end views of a cylindrical light guide bar with patterned surfaces according to embodiments of the present invention.

In the embodiment illustrated in FIG. 2O, the light guide bar 220 of the flicker free light source comprises a round cylindrical shape. A light diffusing pattern 230 is disposed on a light emitting surface of the light guide bar 220. In the embodiment illustrated in FIG. 2P, the light guide bar 220 further comprises a light reflecting pattern 240 disposed on a light reflecting surface opposite the light emitting surface. In the embodiment illustrated in FIG. 2Q the light reflecting pattern 240 on the light guide bar 220 is disposed on the surface of the light guide bar not covered by the light diffusing pattern 230. In this embodiment a maximum amount of light is reflected throughout the light guide bar until the light exits through the light diffusing pattern 230 on the light emitting surface.

Refer to FIGS. 2R-2T, which are drawings illustrating an end view of a light guide bar for a flicker free light source according to embodiments of the present invention.

In the embodiments illustrated in FIGS. 2R-2T the light guide bar 220 comprises a cylindrical shape with a convex mound 235 protruding from the light guide bar 220 to form a light emitting surface. This convex mound 235 on the light guide bar 220 further enhances the quality of emitted light by spreading the light in different directions. In the embodiment illustrated in FIG. 2S the light guide bar 220 further comprises a light diffusing pattern 230 on the convex mound. In the embodiment illustrated in FIG. 2T the light guide bar 220 further comprises a light reflecting pattern 240 on the surface of the light guide bar 220 not covered by the light diffusing pattern 230.

Refer to FIGS. 2U-2X, which are drawings illustrating an end view of a polygonal light guide bar for a flicker free light source according to embodiments of the present invention.

In the embodiment illustrated in FIG. 2U-2W the light guide bar 220 comprises a hexagon shape. In FIG. 2U the light guide bar comprises a light diffusing pattern 230 on a light emitting surface. In FIG. 2V the light guide bar further comprises a light reflecting pattern 240 on a surface opposite the light emitting surface. In FIG. 2W the light reflecting pattern 240 is disposed on the surfaces of the light guide bar 220 not covered by the light diffusing pattern 230.

In the embodiment illustrated in FIG. 2X the light guide bar 220 comprises an octagonal shape.

Refer to FIG. 2Y, which is a drawing illustrating a side view of a light reflecting pattern for a light guide bar according to an embodiment of the present invention.

In the embodiment illustrated in FIG. 2Y the light diffusing pattern 240 comprises a plurality of concaved recesses that increase in size as the light reflecting pattern 240 moves away from the LED light sources.

Refer to FIG. 2Z, which is a drawing illustrating a view of a light reflecting pattern for a light guide bar according to an embodiment of the present invention.

In the embodiment illustrated in FIG. 2Z the light reflecting pattern 240 comprises a plurality of inclined recesses. However, in this embodiment the recesses further comprise angled sides 271 273 274 276 along with faces 272 275. Light emitted by the LED light source 210 enters the light guide bar 220 through the end and travels through the light guide bar and is reflected by the light reflecting pattern. The inclination and depth of the recesses are related to effectively utilize total illumination reflection TIR of the light guide bar. By varying the depth and the incline angle of the plurality of recesses more light is emitted from the light emitting surface of the light guide bar of the flicker free light source.

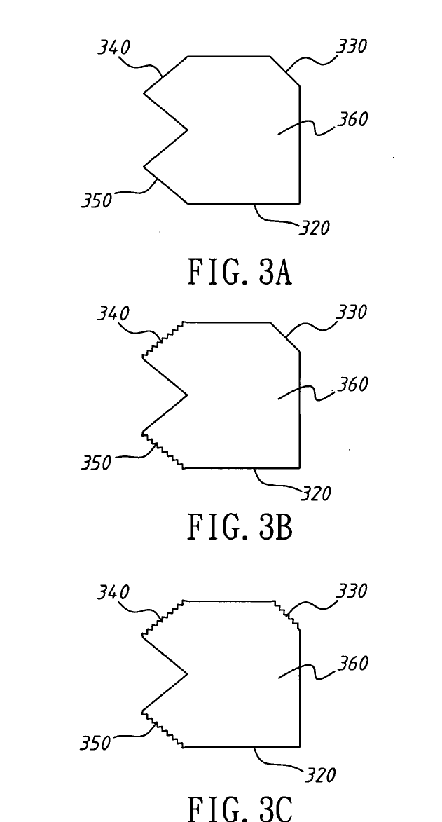

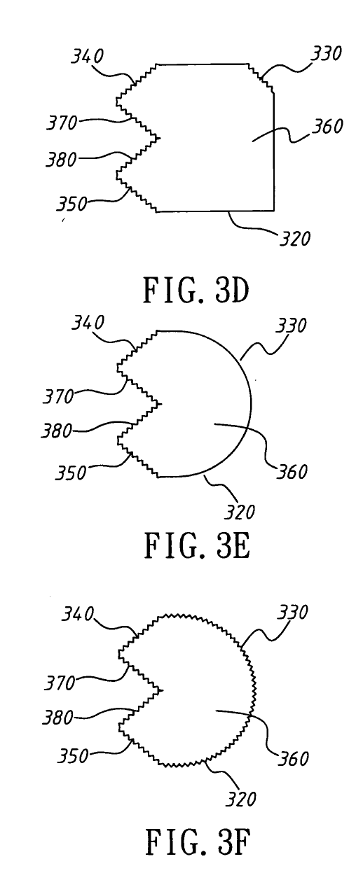

Refer to FIGS. 3A-3D, which are drawings illustrating a polygonal light guide bar with a sigma shaped surface according to embodiments of the present invention.

In the embodiments illustrated in FIGS. 3A-3D the light guide bar 320 comprises a polygonal shape with a sigma shaped surface 340 350 and a concaved end 360. The light guide bar 320 also comprises a light emitting surface 330 and a bottom surface. In the embodiment illustrated in FIG. 3B the light guide bar 320 further comprises a light reflecting pattern on the sigma shaped surface 340 350. In the embodiment illustrated in FIG. 3C the light guide bar 320 further comprises a light diffusing pattern on the light emitting surface 330. In the embodiment illustrated in FIG. 3D the light guide bar 320 further comprises a light reflecting pattern on the remaining surface 370 380 of the sigma shaped surface. In other embodiments of the present invention a light reflecting pattern is disposed on the bottom surface of the light guide bar 320.

Refer to FIGS. 3E-3F, which are drawings illustrating a cylindrical light guide bar with a sigma shaped surface according to embodiments of the present invention.

In the embodiments illustrated in FIGS. 3E-3F the light guide bar 320 is cylindrically shaped with a sigma shaped surface 340 350 360 370. A light reflecting pattern is disposed on the sigma shaped surface 340 350 360 370 to reflect light towards the light emitting surface 330. In FIG. 3F the light guide bar 320 further comprises a light diffusing pattern on the light emitting surface 330.

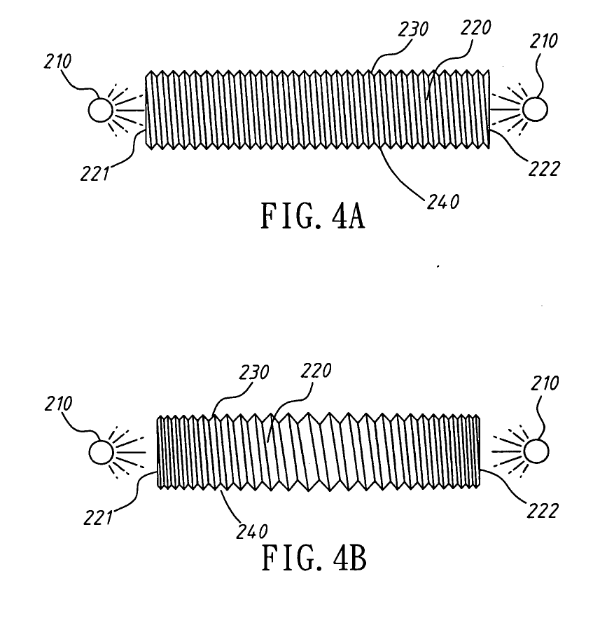

Refer to FIGS. 4A-4B, which are drawings illustrating a flicker free light source with a cylindrical light guide bar having a corkscrew light diffusion pattern according to embodiments of the present invention.

In the embodiment illustrated in FIGS. 4A-4B the light guide bar 220 comprises a corkscrew light diffusing pattern 230 on the surface of the light guide bar 220. In FIG. 4A the corkscrew light diffusing pattern 230 is of uniform pitch. In FIG. 4B the corkscrew light diffusing pattern 230 varies in size. In embodiments of the present invention the pitch of the corkscrew light diffusing pattern increases in pitch moving away from the LED light sources. In other embodiments the pitch decreases in size moving away from the LED light sources. In embodiments of the present invention the size and depth of the corkscrew light diffusing pattern are varied.

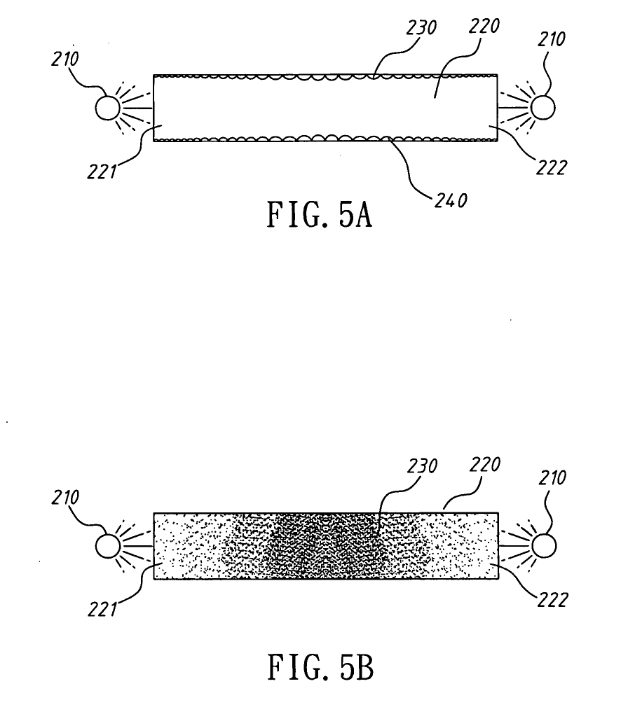

Refer to FIG. 5A, which is a drawing illustrating a flicker free light source with a cylindrical light guide bar having a light diffusing patterned surface and a light reflecting patterned surface according to an embodiment of the present invention.

In the embodiment illustrated in FIG. 5A the light diffusing pattern 230 and the light reflecting pattern 240 of the light guide bar 220 comprise a plurality of concaved recesses on the light diffusing surface and the light reflecting surface.

Refer to FIG. 5B, which is a drawing illustrating a light guide bar with a patterned surface according to embodiments of the present invention.

In the embodiment illustrated in FIG. 5B the light diffusing pattern 230 comprises a plurality of semi-random indentations. For example, the pattern is similar to the effect seen on the surface of an object that has been sandblasted. In embodiments of the present invention the indentations are uniform. In other embodiments the size of the indentations is varied. For example, closer to the LED light sources the indentations are smaller and moving towards the center of the light guide bar the indentations gradually become larger. In embodiments of the present invention the density of the indentations is varied.

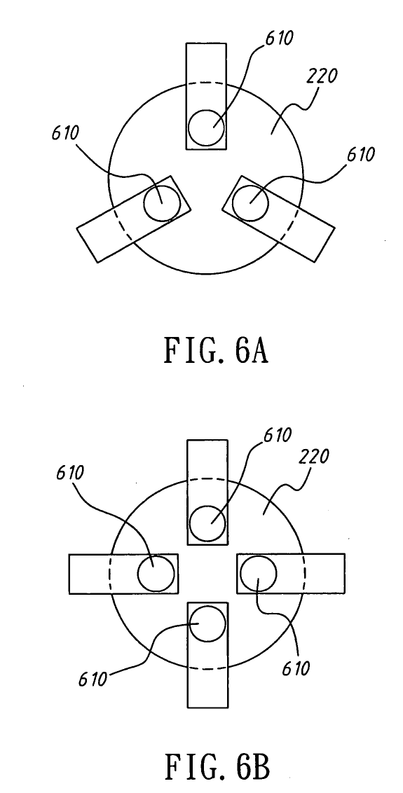

Refer to FIGS. 6A-6B, which are drawings illustrating LED arrangement for a flicker free light source according to embodiments of the present invention.

In the embodiment illustrated in FIG. 6A the flicker free light source comprises three LED light sources 610 disposed facing the concaved end or ends of the light guide bar 220 and arranged so that an equal amount of space is situated between the LED light sources 610. The colors of the LED light sources 610 comprise, for example, a red LED, a blue LED, and a green LED.

In the embodiment illustrated in FIG. 6B the flicker free light source comprises four LED light sources 610 positioned equally apart from each other.

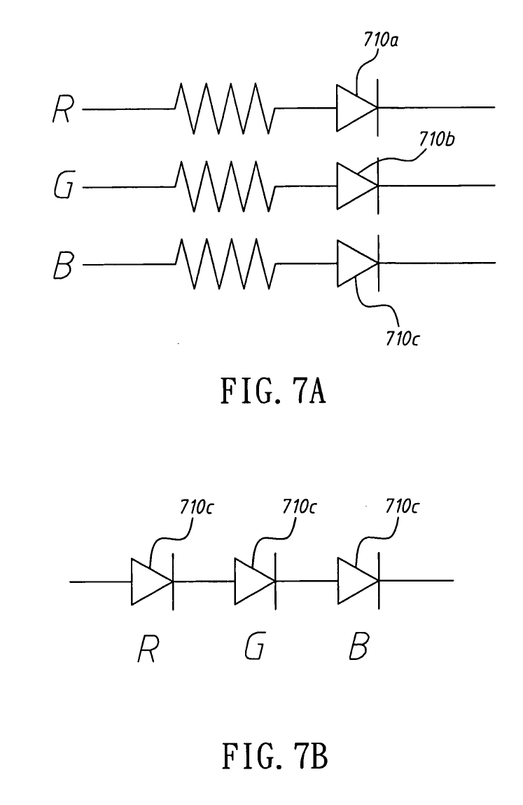

Refer to FIGS. 7A-7B, which are drawings illustrating LED coupling for a flicker free light source according to embodiments of the present invention.

In the embodiment illustrated in FIG. 7A the LEDs of the LED light source comprise a red LED 710a, a green LED 710b, and a blue LED 710c connected in parallel. By coupling the LEDs in parallel the color of the emitted light is varied by changing the amount of current.

In the embodiment illustrated in FIG. 7B the LEDs 710a 710b 710c of the LED light source are connected in series. Coupling the LEDs in series allows manufacturers or suppliers flexibility in LED or LED chip selection.

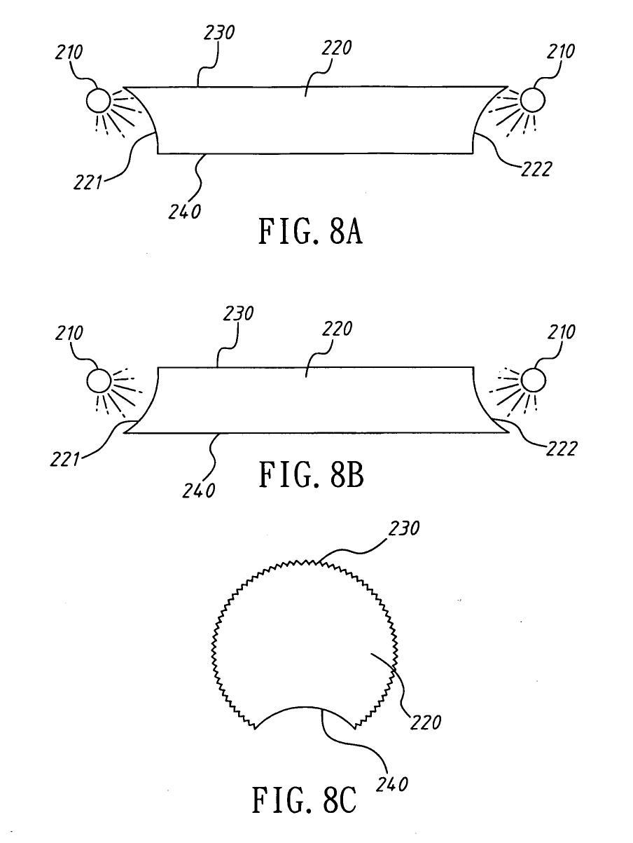

Refer to FIGS. 8A-8B, which are drawings illustrating a flicker free light source with a light guide bar having concaved and slanted ends according to embodiments of the present invention.

In the embodiment illustrated in FIG. 8A the light guide bar 220 comprises concaved ends 221 222 that are slanted so that the concave is aimed towards the light diffusing pattern 230 on the light emitting surface. With this arrangement, light emitted by the LED light sources 210 is directed towards the light diffusing pattern 230. This increases the intensity of the emitted light.

In the embodiment illustrated in FIG. 8B the concaved ends 221 222 are slanted downwards in order to direct the light toward the light reflecting pattern 240. This increases the uniformity of the emitted light.

Refer to FIG. 8C, which is a drawing illustrating an end view of a light guide bar according to an embodiment of the present invention.

In the embodiment illustrated in FIG. 8C the light guide bar 220 comprises a cylindrical shape with a light reflecting pattern 240 on a concaved light reflecting surface. A light diffusing pattern 230 is disposed on the light emitting surface. In embodiments of the present invention the light reflecting pattern is as previously described in the previous embodiments. In other embodiments of the present invention the light reflecting pattern comprises a coating or paint.

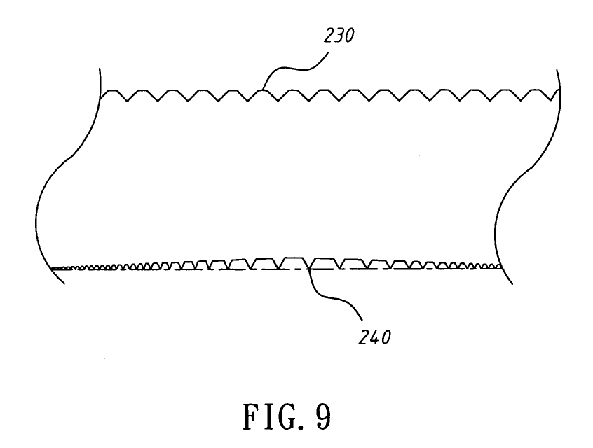

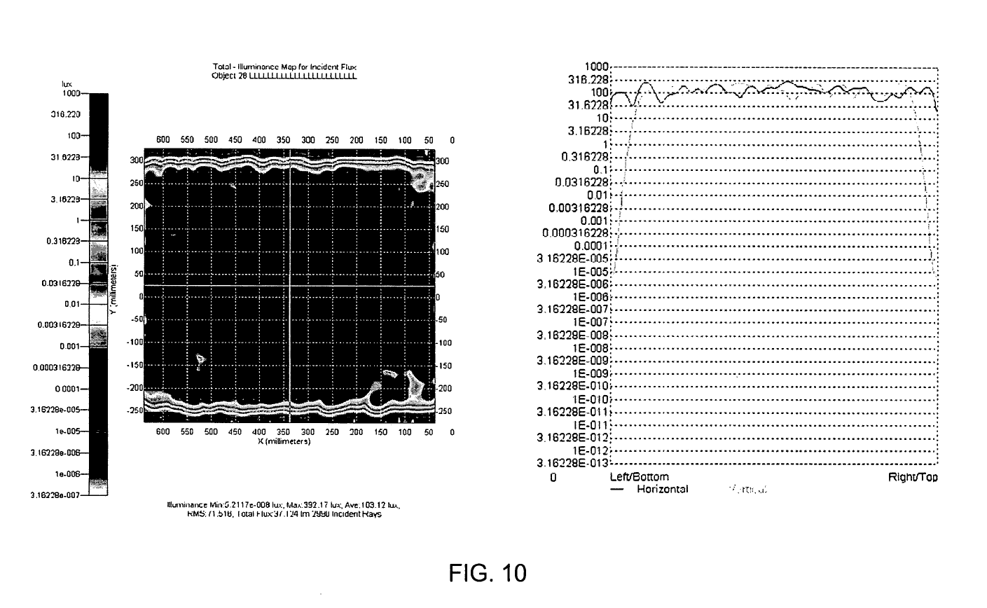

Refer to FIG. 9, which is a drawing illustrating an enlarged view of the light diffusing pattern and the light reflecting pattern according to an embodiment of the present invention.

In the embodiment illustrated in FIG. 9, the light diffusing pattern on the light emitting surface is uniform in size and the light reflecting pattern grows increasingly larger closer to the middle of the light guide bar. The light diffusing pattern comprises a plurality of notches that are shaped like flat topped peaks with valleys between the peaks. The light reflecting pattern comprises a plurality of notches that are shaped like peaks with flat valleys between the peaks. The notches gradually increase in size. The peaks grow larger and the valleys grow wider.

Refer to FIG. 10, which is a diagram illustrating illumination results using the linear light source of the present invention.

The illumination maps shown in FIG. 10 clearly illustrate the enhanced uniformity and illumination of the high powered LED linear lighting of the present invention.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A light guide bar comprising:
a first end and a second end for receiving light emitted by at least one light emitting diode; and
a light emitting surface for emitting the light; and
a light diffusing pattern on the light emitting surface.

2. The light guide bar of claim 1, further comprising:
a light reflecting surface for reflecting the light.

3. The light guide bar of claim 1, the light diffusing pattern diffusing the light.

4. The light guide bar of claim 2, further comprising:
a light reflecting pattern on the light reflecting surface.

5. The light guide bar of claim 3, the light diffusing pattern comprising a plurality of indentations of varying sizes.

6. The light guide bar of claim 5, the plurality of indentations increasing in size away from the at least one light emitting diode.

7. The light guide bar of claim 3, the light diffusing pattern comprising a plurality of peaks and valleys.

8. The light guide bar of claim 7, the plurality of peaks and valleys increasing in size away from the at least one light emitting diode.

9. The light guide bar of claim 3, the light diffusing pattern comprising a plurality of notches.

10. The light guide bar of claim 3, the light diffusing pattern comprising a plurality of convex mounds, a plurality of concave dimples, or a combination of these.

11. The light guide bar of claim 3, the light diffusing pattern comprising a corkscrew pattern.

12. The light guide bar of claim 11, the corkscrew pattern varying in pitch away from the at least one light emitting diode.

13. The light guide bar of claim 1, the light guide bar is a cylindrical shaped light guide bar.

14. The light guide bar of claim 2, the light guide bar is a polygonal shaped light guide bar and the light reflecting pattern is disposed on a sigma shaped surface of the polygonal shaped light guide bar.

15. The light guide bar of claim 3, the light guide bar further comprising a light reflecting pattern opposite the light diffusing pattern and the light diffusing pattern and the light reflecting pattern are offset by 50%.

16. The light guide bar of claim 3, the light guide bar further comprising a light reflecting pattern opposite the light diffusing pattern and the light diffusing pattern and the light reflecting pattern comprising identical patterns.

17. The light guide bar of claim 3, the light guide bar further comprising a light reflecting pattern opposite the light diffusing pattern and the light diffusing pattern and the light reflecting pattern varying in density away from the at least one light emitting diode.

18. The light guide bar of claim 4, the light reflecting pattern comprising a plurality of recesses of varying depth and incline angle.

19. The light guide bar of claim 1, the first end and the second end being concaved and slanted for directing the light towards the light emitting surface.

20. The light guide bar of claim 1, the first end and the second end being concaved and slanted for directing the light away from the light emitting surface.

21. A light guide bar comprising:
a first end;
a second end; the first end and the second end receiving light emitted by light emitting diodes;
a light emitting surface for emitting the light; and
a light diffusing pattern on the light emitting surface.

22. The light guide bar of claim 21, further comprising:
a light reflecting surface for reflecting the light.

23. The light guide bar of claim 21, the light diffusing pattern diffusing the light.

24. The light guide bar of claim 22, further comprising:
a light reflecting pattern on the light reflecting surface.

25. The light guide bar of claim 23, the light diffusing pattern comprising a plurality of indentations of varying sizes.

26. The light guide bar of claim 25, the plurality of indentations increasing in size away from the light emitting diodes.

27. The light guide bar of claim 23, the light diffusing pattern comprising a plurality of peaks and valleys.

28. The light guide bar of claim 27, the plurality of peaks and valleys increasing in size away from the light emitting diodes.

29. The light guide bar of claim 23, the light diffusing pattern comprising a plurality of notches.

30. The light guide bar of claim 23, the light diffusing pattern comprising a plurality of convex mounds, a plurality of concave dimples, or a combination of these.

31. The light guide bar of claim 23, the light diffusing pattern comprising a corkscrew pattern.

32. The light guide bar of claim 31, the corkscrew pattern varying in pitch away from the light emitting diodes.

33. The light guide bar of claim 21, the light guide bar is a cylindrical shaped light guide bar.

34. The light guide bar of claim 24, the light guide bar is a polygonal shaped light guide bar and the light reflecting pattern disposed on a sigma shaped surface of the polygonal shaped light guide bar.

35. The light guide bar of claim 23, the light guide bar further comprising a light reflecting pattern opposite the light diffusing pattern and the light diffusing pattern and the light reflecting pattern are offset by 50%.

36. The light guide bar of claim 23, the light guide bar further comprising a light reflecting pattern opposite the light diffusing pattern and the light diffusing pattern and the light reflecting pattern comprising identical patterns.

37. The light guide bar of claim 23, the light guide bar further comprising a light reflecting pattern opposite the light diffusing pattern and the light diffusing pattern and the light reflecting pattern varying in density away from the light emitting diodes.

38. The light guide bar of claim 24, the light reflecting pattern comprising a plurality of recesses of varying depth and incline angle.

39. The light guide bar of claim 21, the first end and the second end being concaved and slanted for directing the light towards the light emitting surface.

40. The light guide bar of claim 21, the first end and the second end being concaved and slanted for directing the light away from the light emitting surface.
